(19) United States
(12) Patent Application Publication
(10) Pub. No.: US 2007/0241997 A1
(43) Pub. Date: Oct. 18, 2007

(54) METHOD FOR DRIVING PLASMA DISPLAY PANEL

(76) Inventor: Yoshiho Seo, Akashi-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/672,100

(22) Filed: Feb. 7, 2007

(30) Foreign Application Priority Data
Apr. 13, 2006 (JP) 2006-111235

(51) Int. Cl. G09G 3/28

(52) U.S. Cl. 345/68

(57) ABSTRACT

For display using a plasma display panel including a screen made up of cells each of which has an address discharge portion controlled by a scan electrode and a data electrode and a priming discharge portion that is controlled by the scan electrode and an auxiliary electrode and tends to generate a discharge more easily than the address discharge portion, in a period when addressing operation is performed, scan pulses are applied to the scan electrodes sequentially, in parallel with the application of the scan pulses, address pulses are selectively applied to the data electrodes depending on display data, and potential of the auxiliary electrodes is so controlled that discharges are generated in the priming discharge portions in the cells of a selected row responsive to the application of the scan pulses to the scan electrodes irrespective of whether or not the address pulses are applied to the data electrodes.

### BACKGROUND OF THE INVENTION

1. Field of the Invention

The present invention relates to a method for driving a Plasma Display Panel (PDP).

2. Description of the Related Art

Three-electrode surface discharge AC plasma display panels are used for displaying color images. The three-electrode surface discharge type described herein is a type in which first electrodes and second electrodes both of which are used for generating display discharges are arranged in parallel with each other on a front substrate or a rear substrate, and third electrodes are arranged on the rear substrate or the front substrate so as to cross the first electrodes and the second electrodes.

For display, line-sequential scanning type data write operation (addressing operation) is performed in which a suitable amount of wall charge is formed in cells to be lit among cells arranged in a matrix, and after that, lighting sustain operation (sustain operation) is performed in which the wall charge is used to generate display discharges plural times depending on gradation values of display data. In the addressing operation, the second electrodes are used as scan electrodes for row selection while the third electrodes are used as data electrodes for column selection. In the sustain operation, the first electrodes and the second electrodes make electrode pairs for generating display discharges.

In general, prior to the addressing operation, initializing operation called “reset” is performed. One of the purposes for performing the reset is to equalize charge accumulation states of all the cells to cancel binary setting for amounts of wall charge in previous addressing operation. The other purpose is to generate priming particles that facilitate generation of address discharges in the subsequent addressing operation.

Japanese Patent Publication No. 2581465 is directed to generation of priming particles. The publication proposes a panel structure including priming electrodes that are fourth electrodes for facilitating generation of priming discharges. For example, the priming electrodes are arranged close to and in parallel with scan electrodes. Thereby, priming discharge portions where discharges occur due to application of low voltage are formed in cells. The publication describes a driving method in which, prior to addressing operation, the priming electrodes are used to generate priming discharges in all the cells.

Priming particles generated by discharges decrease as time passes. For this reason, conventional driving methods in which priming particles are generated before starting addressing operation have a problem that address discharge errors occur more often as the addressing operation progresses. Address discharge errors are liable to occur, especially, in a panel structure in which a discharge gas space is divided on a cell basis. This is because few priming particles flow from other cells into each cell. Further, priming particles disappear early in a high-definition screen in which a cell size is small. This is because the probability of particle collision that causes charge neutralization is high. In addition to the early disappearance of priming particles, the number of rows is large and the time required for addressing operation is long in the high-definition screen, resulting in a high frequency of occurrence of address discharge errors.

The address discharge errors are reduced by increasing a pulse width of a pulse to be applied to improve a discharge probability. If such is the case, however, time to be assigned to addressing operation is increased and time that can be assigned to sustain operation is shortened. An expensive driving circuit including many components is required to divide a screen and perform addressing operation concurrently for plural sections of the screen in order to shorten the time required for addressing operation.

### SUMMARY

The present disclosure is directed to solve the problems pointed out above, and therefore, an object of an embodiment of the present invention is to reduce the occurrence of address discharge errors without increasing the time required for addressing operation.

Priming discharges for triggering address discharges caused between scan electrodes and data electrodes are generated by scan pulses applied to the scan electrodes in line-sequential addressing operation. Since priming particles are generated for each application of scan pulse, regardless of the number of scan electrodes, address discharges can be generated also in rows selected near the end of addressing operation as in rows selected early.

According to an embodiment of the present invention, a plasma display panel to which a driving method for achieving the objects described above is applied includes a plurality of scan electrodes for row selection, a plurality of data electrodes for column selection, a plurality of auxiliary electrodes for generating priming discharges, and cells making up of a screen. Further, each cell making up of a screen of the plasma display panel includes an address discharge portion that is controlled by the scan electrode and the data electrode and a priming discharge portion that is controlled by the scan electrode and the auxiliary electrode and tends to generate a discharge more easily than the address discharge portion.

According to an embodiment of the present invention, a driving method for achieving the objects includes, in a period when the addressing operation is performed, applying scan pulses to the scan electrodes sequentially, in parallel with the application of the scan pulses, applying address pulses selectively to the data electrodes depending on display data, the address pulses being for generating discharges in the address discharge portions, and controlling potential (electric potential) of the auxiliary electrodes so that discharges are generated in the priming discharge portions in the cells of a selected row in response to the application of the scan pulses to the scan electrodes irrespective of whether or not the address pulses are applied to the data electrodes.

The structure described above makes it possible to reduce the occurrence of address discharge errors without increasing the time required for addressing operation.

These and other characteristics and objects of the present invention will become more apparent by the following descriptions of preferred embodiments with reference to drawings.

### BRIEF DESCRIPTION OF THE DRAWINGS

FIG. 1 is an exploded perspective view showing cell structures of a plasma display panel.

FIG. 2 is a sectional view showing a substantial part of the plasma display panel.

FIG. 3 is a plan view showing an electrode structure of the plasma display panel.

FIG. 4 is a plan view showing a modified example of an auxiliary electrode.

FIG. 5 shows drive voltage waveforms showing an example of a drive sequence in a subframe.

FIG. 6 is a plan view showing another example of an electrode structure of a plasma display panel.

FIG. 7 is a sectional view showing a modified example of an auxiliary electrode arrangement.

FIG. 8 is a sectional view showing a modified example of an auxiliary electrode arrangement.

FIG. 9 is a sectional view showing a modified example of a combination of a display electrode arrangement and an auxiliary electrode arrangement.

### DESCRIPTION OF THE PREFERRED EMBODIMENTS

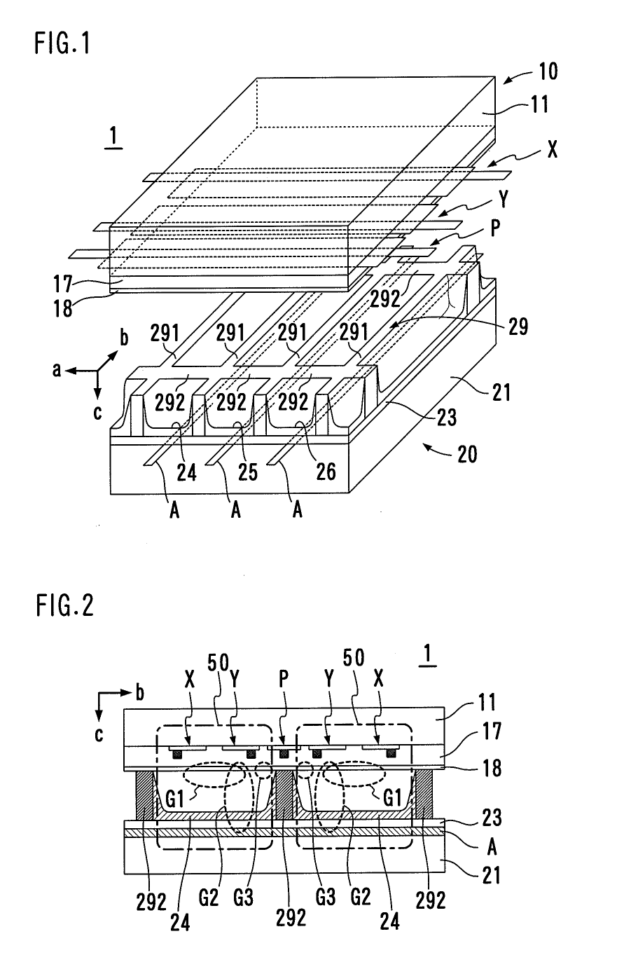

A surface discharge AC plasma display panel shown in FIGS. 1-3 is suitable to practice an embodiment of the present invention.

Referring to FIG. 1, the plasma display panel 1 includes a front panel 10, a rear panel 20 and a discharge gas (not shown). While being separated from each other in the drawing, in effect, the front panel 10 abuts on the rear panel 20.

The front panel 10 includes a glass substrate 11, first display electrodes X, second display electrodes Y, auxiliary electrodes P, a dielectric layer 17 and a protection film 18. The rear plate 20 includes a glass substrate 21, address electrodes A, a dielectric layer 23, a partition 29, a fluorescent material 24 for red (R), a fluorescent material 25 for green (G) and a fluorescent material 26 for blue (B).

The display electrode X and the display electrode Y make an electrode pair for generating display discharges in the form of surface discharge. The display electrodes Y are used as scan electrodes in addressing operation. The auxiliary electrodes P are electrodes for generating priming discharges. The display electrodes X, the display electrodes Y and the auxiliary electrodes P extend along the row direction of a matrix display and are covered with the dielectric layer 17. The address electrodes A extend along the column direction and are used as data electrodes in the addressing operation.

The partition 29 is a grid-like structure, as viewed from the top, in which a plurality of vertical walls 291 for defining boundaries between columns is integral with a plurality of horizontal walls 292 for defining boundaries between rows. The partition 29 divides a discharge gas space into a matrix, so that discharge interference is prevented between cells as light-emitting elements.

FIG. 2 shows a cross-sectional structure of two cells 50 that are arranged along the address electrode A. Each of the cells 50 includes a display discharge portion G1 controlled by the display electrode X and the display electrode Y, an address discharge portion G2 controlled by the display electrode Y as a scan electrode and the address electrode A (data electrode) and a priming discharge portion G3 controlled by the display electrode Y as a scan electrode and the auxiliary electrode P.

In this example, compared to an electrode gap (a surface discharge gap relating to a display discharge) between the display electrode X and the display electrode Y, an electrode gap between the display electrode Y and the auxiliary electrode P is short. Stated differently, a discharge is generated easily in the priming discharge portion G3, compared to the display discharge portion G1. Here, the phrase “a discharge is generated easily” means that shortening a discharge delay between application of voltage for generating a discharge and commencement of a discharge is relatively easy. In general, as a discharge gap is shorter, a discharge is generated at lower voltage. Accordingly, for example, if voltage for generating a discharge between electrodes between which a discharge gap is long is applied between electrodes between which a discharge gap is short, a discharge delay of a discharge occurring due to the application is shorter than a discharge delay between the electrodes between which a discharge gap is long.

In addition, compared to the distance between the display electrode Y and the address electrode A, the electrode gap between the display electrode Y and the auxiliary electrode P is short. Accordingly, a discharge is easily generated in the priming discharge portion G3 compared to the address discharge portion G2.

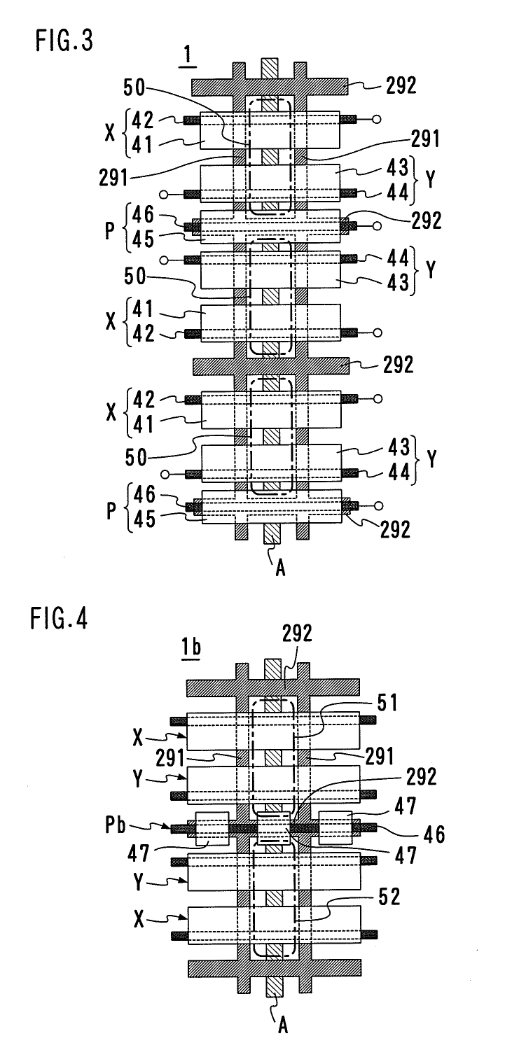

FIG. 3 is a plan view showing an electrode structure of the plasma display panel.

In the plasma display panel 1, the display electrodes X and the display electrodes Y are so arranged that a pair of the display electrode X and the display electrode Y corresponds to one row and the positional relationship between the display electrodes X and the display electrodes Y in the column direction is switched for each row like X-Y, Y-X, X-Y, Y-X, . . . . The auxiliary electrode P is arranged between the display electrode Y and the display electrode Y that are adjacent to each other without sandwiching the display electrode X therebetween. Besides, the auxiliary electrode P is arranged to overlap with the horizontal wall 292. Each of the auxiliary electrodes P corresponds to two neighboring rows.

The display electrode X is a layered film made up of a transparent conductive film 41 for forming a discharge surface with a predetermined area and a metal film 42 for improving conductivity. Likewise, the display electrode Y is made up of a transparent conductive film 43 and a metal film 44, and the auxiliary electrode P is made up of a transparent conductive film 45 and a metal film 46. The transparent conductive film 45 of the auxiliary electrode P has a width larger than a width of the horizontal wall 292, and therefore the transparent conductive film 45 extends beyond the horizontal wall 292 on both sides. The metal film 46 of the auxiliary electrode P is placed at the middle portion of the transparent conductive film 45 in the width direction. Since the metal film 46 has a width smaller than the width of the horizontal wall 292, the auxiliary electrode P does not shield display light.

Terminals, which connect to a driving circuit, of the display electrodes X and the auxiliary electrodes P are placed on one side of a screen (the right side in the drawing) and terminals of the display electrodes Y are placed on the other side (the left side in the drawing). In this way, distributing the terminals on the right side and the left side facilitates connection to the driving circuit.

FIG. 4 is a plan view showing a modified example of the auxiliary electrode.

In a plasma display panel 1b shown in FIG. 4, an auxiliary electrode Pb is made up of a plurality of transparent conductive films 47 that are independently placed for each column and a metal film 46 that overlaps with the transparent conductive films 47. In this electrode structure, dimensions, positions and shapes of the transparent conductive films 47 in the row direction can be selected, in addition to an electrode gap between the auxiliary electrode Pb and the display electrode Y. Accordingly, it is easy to optimize a size and intensity of a discharge in the priming discharge portion G3 (see FIG. 2).

The following is a description of a method for driving the plasma display panels 1 and 1b.

A well-known subframe method is used for display using the plasma display panel 1 or 1b. Specifically, a frame that is an input image is divided into a predetermined number of suframes in order to reproduce gradations with the cells 50 that are binary light-emitting elements. Then, each of the cells 50 within the screen is made to emit light in a subframe that is selected depending on a value of a gradation to be displayed. Addressing operation is performed for each subframe in order to generate display discharges only in cells 50 to be lit.

A characteristic of the method for driving the plasma display panels 1 and 1b is to generate priming discharges in synchronization with row selection in addressing operation. More specifically, the characteristic is to generate priming discharges in the priming discharge portions G3 of cells in a selected row by scan pulses to be applied for row selection. The priming discharge serves to supply the address discharge portions G2 with priming particles that produce an effect of ensuring early generation of address discharges.

For the purpose of enhancing the reliability of such addressing operation, it is desirable that variations of charge states among the cells are reduced in reset operation before the addressing operation. To that end, an approach is suitable in which discharge initiation characteristics are equalized by applying voltage having a dull waveform to generate microdischarges for adjusting an amount of wall charge.

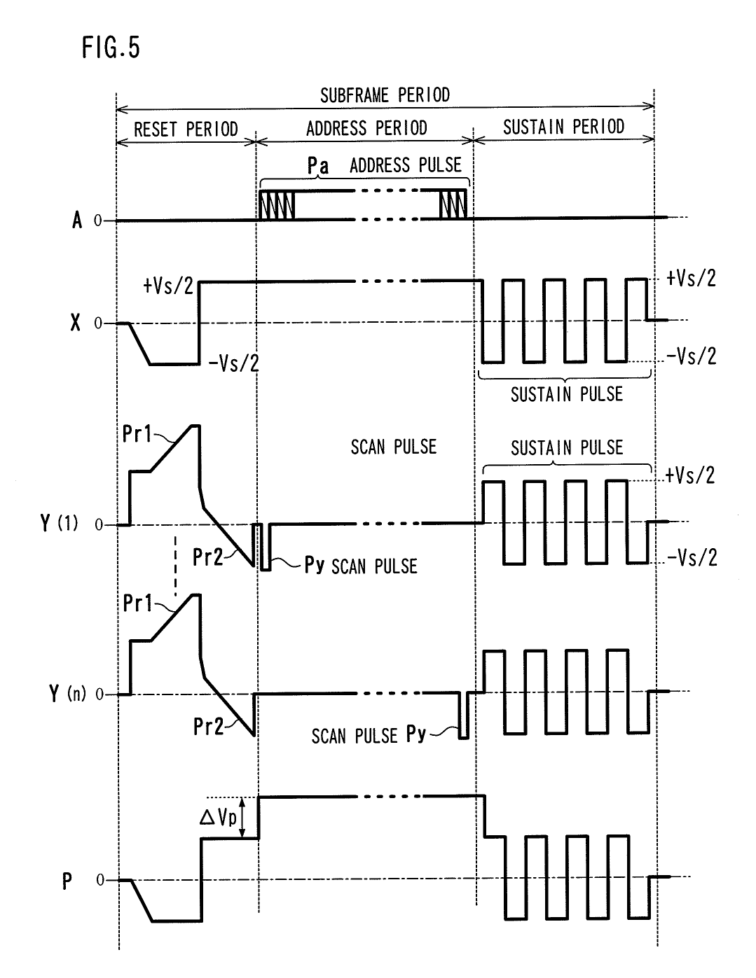

FIG. 5 shows drive voltage waveforms showing an example of a drive sequence in a subframe. Although driving the plasma display panel 1 is assumed in the illustrated example, similar waveforms can be applied also to the plasma display panel 1b. In the drawing, waveforms relating to the address electrodes A, the display electrodes X and the auxiliary electrodes P are shown collectively. As for the display electrodes Y, waveforms relating to the display electrode Y(1) in the first row and the display electrode Y(n) in the last row are shown. The illustrated waveforms are one example and amplitudes, polarities and timing thereof can be variously modified. The pulse base potential is not limited to the ground potential.

Each of the subframes has a reset period, an address period and a sustain period. In the reset period, initialization is performed to equalize wall voltage of all the cells in the screen. In the address period, addressing operation is performed to control the wall voltage of all the cells depending on display data. In the sustain period, sustain operation is performed to generate display discharges only in cells to be lit. One frame is displayed by repeating the initialization, the addressing operation and the sustain operation.

In the reset period, a positive pulse Pr1 having a dull waveform and a negative pulse Pr2 having a dull waveform are sequentially applied to the display electrodes Y. Stated differently, bias control for raising the potential of the display electrodes Y monotonically and bias control for lowering the same monotonically are performed. On this occasion, an offset bias is given to the display electrodes X in order to accelerate the increase in voltage between electrodes. In the illustrated example, the bias potential is −Vs/2 or +Vs/2. When a positive pulse Pr2 having a dull waveform is applied, an offset bias is given also to the display electrodes Y in order to accelerate the approach to predetermined potential. The potential of the address electrodes A are maintained at the ground potential, i.e., zero volts during the entire reset period. The same potential control as in the case of the display electrodes X is performed on the auxiliary electrodes P. Specifically, the potential of the auxiliary electrodes P is so controlled that the polarity of voltage between the display electrode Y and the display electrode X (hereinafter referred to as a YX-interelectrode) and the polarity of voltage between the display electrode Y and the auxiliary electrode P (hereinafter referred to as a YP-interelectrode) are constantly equal to each other during the reset period.

At the end point of application of the last dull waveform in the reset period, voltage at the YX-interelectrode is almost equal to discharge initiation voltage at the YX-interelectrode. Specifically, the display discharge portion G1 of each of the cells 50 is in the wall charge formation state in which a discharge is generated in response to application of voltage higher than voltage at the end point of application of the last dull waveform. Likewise, voltage at the YP-interelectrode is almost equal to discharge initiation voltage at the YP-interelectrode. Then, the priming discharge portion G3 of each of the cells 50 is in the wall charge formation state in which a discharge is generated in response to application of voltage higher than voltage at the end point of application of the last dull waveform.

In the address period, the display electrodes X are biased to positive potential continuously from the reset period. The display electrodes Y are once set to the ground potential, and after that, scan pulses Py are sequentially applied to the display electrodes Y one by one. In short, row selection is performed. The polarity of the scan pulse Py is the same polarity as that of the last dull waveform pulse Pr2 in the reset period (negative polarity in the illustrated example). In addition, the amplitude of the scan pulse Py is almost equal to the amplitude of the dull waveform pulse Pr2. Thus, the application of the scan pulses Py puts the display discharge portions G1 of all the cells 50 into the state where a discharge is generated easily. It is possible that the amplitude of the scan pulse Py is made to be slightly large and a weak priming discharge is generated in the display discharge portion G1.

In the address period, in synchronization with the row selection, address pulses are applied to the address electrodes A corresponding to cells to be lit in the selected row. Thereby, address discharges occur in the address discharge portions G2 of the selected cells 50. This triggers the occurrence of discharges in the display discharge portions G1. In other words, the address discharges expand to discharges in the address discharge portions G2 and the display electrodes Y.

For the purpose of ensuring the early start of such address discharges, the auxiliary electrodes P are so biased, in the address period, that priming discharges are generated in the priming discharge portions G3 responsive to the scan pulse Py. More specifically, the auxiliary electrodes P are biased to potential higher than that when the dull waveform pulse Pr2 is applied in the reset period by a value indicated by ΔVp.

Priming discharges occur in all the cells in the selected row irrespective of whether or not address pulses are applied. Relatively strong priming discharges occur in cells to which address pulses are applied. The priming discharge shortens a discharge delay of address discharges in the address discharge portions G2. Accordingly, even if the width of the scan pulse is shortened, an address discharge error is less likely to occur. Further, in the present driving method in which priming discharges are generated for each row selection, address discharge errors can be prevented irrespective of the number of scan electrodes, differently from a driving method in which priming discharges are generated before the start of the address period.

In the sustain period, sustain pulses having a negative polarity and sustain pulses having a positive polarity are alternately applied to all the display electrodes X, and sustain pulses having a positive polarity and sustain pulses having a negative polarity are alternately applied to all the display electrodes Y. The amplitude of the sustain pulses is a half of that of sustain voltage (Vs). Sustain pulses having different polarities are simultaneously applied to the display electrodes X and the display electrodes Y and thereby sustain voltage whose absolute value Vs is, for example, 180 volts is applied at the YX-interelectrode concurrently. The sustain voltage causes sustain discharges in cells to be lit. The number of times of application of the sustain voltage is a number depending on a luminance weight of the subframe.

In the sustain period, the potential of the auxiliary electrodes P is controlled to be equal to that of the display electrodes Y in order to reduce the consumption of reactive power at the YP-interelectrode. For example, sustain pulses are applied to the auxiliary electrodes P as in the display electrodes Y. Since each of the auxiliary electrodes P is sandwiched between two of the display electrodes Y, the potential of the auxiliary electrodes P is almost equal to that of the display electrodes Y even if a current path to the auxiliary electrodes P is put into the high-impedance state.

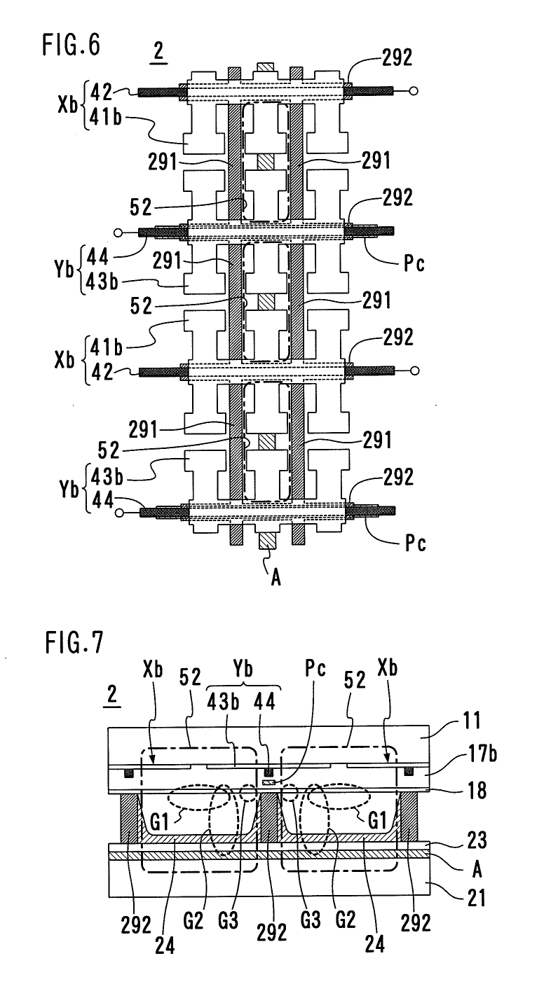

The driving method as described above is applicable also to plasma display panels having structures shown in FIGS. 6-9.

In a plasma display panel 2 as shown in FIGS. 6 and 7, display electrodes Xb and display electrodes Yb are so arranged that one electrode is shared for display for the two neighboring rows. An auxiliary electrode Pc is placed to overlap with the display electrode Yb.

The display electrode Xb is made up of a transparent conductive film 41b that is patterned to have a T-shaped discharge surface in a cell 52 and the metal film 42 having a straight strip shape. Likewise, the display electrode Yb is made up of a transparent conductive film 43b and the metal film 44.

As shown in FIG. 7, the auxiliary electrode Pc is buried in a dielectric layer 17b attached to the front substrate 11 and is placed between the metal film 44 of the display electrode Yb and the horizontal wall 292. Each of the cells 52 includes the display discharge portion G1, the address discharge portion G2 and the priming discharge portion G3.

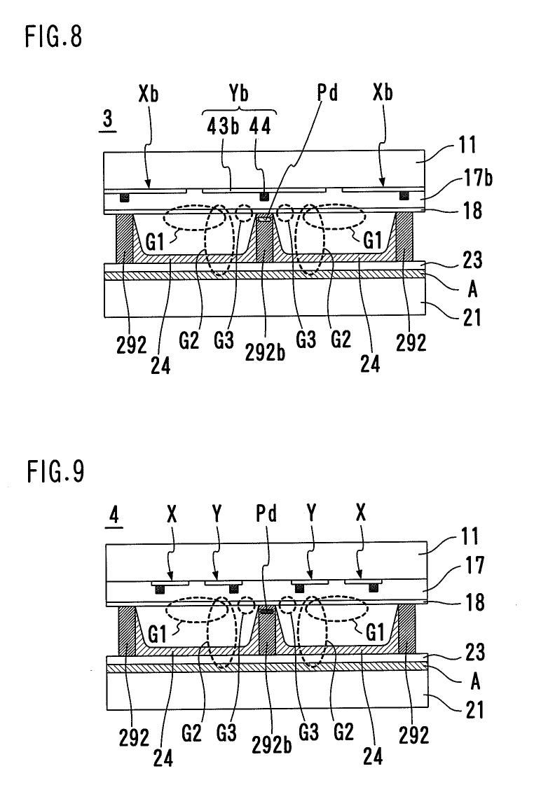

A plasma display panel 3 shown in FIG. 8 includes display electrodes Xb and display electrodes Yb that are arranged in the same manner as in the plasma display panel 2 described above. In the plasma display panel 3, an auxiliary electrode Pd is buried in a horizontal wall 292b at a position close to the display electrode Yb.

In a plasma display panel 4 shown in FIG. 9, an auxiliary electrode Pd is buried in a horizontal wall 292b at a position close to the display electrode Yb as in the case of the plasma display panel 3 described above. The plasma display panel 4 includes display electrodes X and display electrodes Y that are arranged in the same manner as in the plasma display panel 1 shown in FIGS. 1-3.

According to the embodiments described above, address discharge errors can be reduced even in a panel structure in which the cells 50 or 52 have discharge gas spaces enclosed by a partition, i.e., in a panel structure in which priming particles hardly travel among the cells. Priming particles contributing to address discharges can be generated even in a panel structure in which the cell size is small and priming particles disappear relatively early.

While the plasma display panels 1, 1b, 2, 3 and 4 having the partition 29 with a grid-like shape as viewed from the top are shown in the embodiments described above, the present invention is also applicable to drive of a plasma display panel having a stripe structure partition in which only plural vertical walls 291 are provided.

In order to easily generate discharges in the priming discharge portions G3, the dielectric may be formed to be thinner, or a material may be changed locally, except for narrowing interelectrode. It is sufficient that, in the priming discharge portions G3, discharges occur quickly in response to voltage application and the smallest possible discharges occur within a range in which a necessary amount of priming particles is obtained.

The structures described above accelerate addressing operation and improve the reliability thereof. Thus, the present invention is useful for high resolution and high definition of screens of plasma display panels.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A method for driving a plasma display panel in which line-sequential addressing operation is performed, the plasma display panel to be driven including a plurality of scan electrodes for row selection, a plurality of data electrodes for column selection, a plurality of auxiliary electrodes for generating priming discharges, and cells making up of a screen, each of the cells having an address discharge portion that is controlled by the scan electrode and the data electrode and a priming discharge portion that is controlled by the scan electrode and the auxiliary electrode and tends to generate a discharge more easily than the address discharge portion, the method comprising:
in a period when the addressing operation is performed,
applying scan pulses to the scan electrodes sequentially,
in parallel with the application of the scan pulses, applying address pulses selectively to the data electrodes depending on display data, the address pulses being for generating discharges in the address discharge portions, and
controlling potential of the auxiliary electrodes so that discharges are generated in the priming discharge portions in the cells of a selected row in response to the application of the scan pulses to the scan electrodes irrespective of whether or not the address pulses are applied to the data electrodes.

2. The method according to claim 1, further comprising performing common potential control to all of the auxiliary electrodes.

3. The method according to claim 1, further comprising
before starting the addressing operation, applying voltage having a dull waveform for charge control to a display discharge portion of each of the cells, the voltage having a same polarity as that of the scan pulses, and
in the period when the addressing operation is performed, applying voltage between the scan electrode and the auxiliary electrode in each of the cells, the voltage being equal to or higher than voltage to be applied between the scan electrode and the auxiliary electrode during the application of the voltage having the dull waveform.

4. The method according to claim 1, further comprising
before starting the addressing operation, applying a pulse having a dull waveform for charge control to the scan electrode of each of the cells, the pulse having a negative polarity, and
in the period when the addressing operation is performed, applying scan pulses having a negative polarity to the scan electrodes sequentially, in parallel with the application of the scan pulses, applying address pulses having a positive polarity to the data electrodes selectively depending on display data, and maintaining potential of all of the auxiliary electrodes at potential higher than potential during the application of the pulse having the dull waveform.
